(19) United States
(12) Patent Application Publication
(10) Pub. No.: US 2014/0379591 A1
(43) Pub. Date: Dec. 25, 2014

(54) SYSTEM AND METHOD FOR IDENTIFICATION OF LAW CHANGES BETWEEN JURISDICTIONS

(71) Applicant: Avaya Inc., Basking Ridge, NJ (US)

(72) Inventor: Nic Benner, Thornton, CO (US)

(21) Appl. No.: 13/926,989

(22) Filed: Jun. 25, 2013

(51) Int. Cl. G06Q 50/18; G06Q 10/00

(52) U.S. Cl. CPC G06Q 50/18; G06Q 10/00
USPC 705/311

(57) ABSTRACT

A request is received to identify laws in two or more jurisdictions that are associated with a behavior, a substance, an item, and/or a device. A first law associated with the behavior, the substance, the item and/or the device in a first jurisdiction is identified. A second law associated with the behavior, the substance, the item, and/or the device in a second jurisdiction is identified. Information is generated that is associated with the first law or the second law based on the respective jurisdiction. This information is presented to the user to assist the user in being compliant with the laws in the different jurisdictions.

### TECHNICAL FIELD

The systems and methods relate to legal systems and in particular to identification of laws based on a location.

### BACKGROUND

The laws in different jurisdictions (e.g., between countries or states) may vary. For example, a newspaper that is printed in one country may not be legally carried into another country or a particular type of firearm may be legal in one state, but not another. Many times, a person who is traveling between different jurisdictions may be unaware of the laws in a different jurisdiction. This can result in cases where an unsuspecting traveler may unknowingly be breaking laws when he or she enters a new jurisdiction. This problem can be exacerbated if the user is planning a long trip that crosses many different jurisdictions with varying laws. With existing systems, it is difficult for a traveler to ascertain the laws of the various jurisdictions. What is needed is a proactive way to inform a traveler of any changes in laws between different jurisdictions.

### SUMMARY

Systems and methods are provided to solve these and other problems and disadvantages of the prior art. A request is received to identify laws in two or more jurisdictions that are associated with a behavior, a substance, an item, and/or a device. A first law associated with the behavior, the substance, the item and/or the device in a first jurisdiction is identified. A second law associated with the behavior, the substance, the item, and/or the device in a second jurisdiction is identified. Information is generated that is associated with the first law or the second law based on the respective jurisdiction. This information is presented to the user to assist the user in being compliant with the laws in the different jurisdictions.

### BRIEF DESCRIPTION OF THE DRAWINGS

FIG. 1 is a block diagram of a first illustrative system for identification of laws between jurisdictions.

FIG. 2 is a flow diagram of a method for identifying laws between jurisdictions.

FIG. 3 is a flow diagram of a method for identifying differences in laws between jurisdictions.

FIG. 4 is a flow diagram of a method for determining if a law is more restrictive in a different jurisdiction.

FIG. 5 is a flow diagram of a method for determining if a user is in compliance with the laws in an entered jurisdiction.

FIG. 6 is a flow diagram of a method for detecting if a behavior, a substance, an item, and/or a device is with a user or being performed by the user in a jurisdiction where the behavior, the substance, the item, and/or the device is illegal.

### DETAILED DESCRIPTION

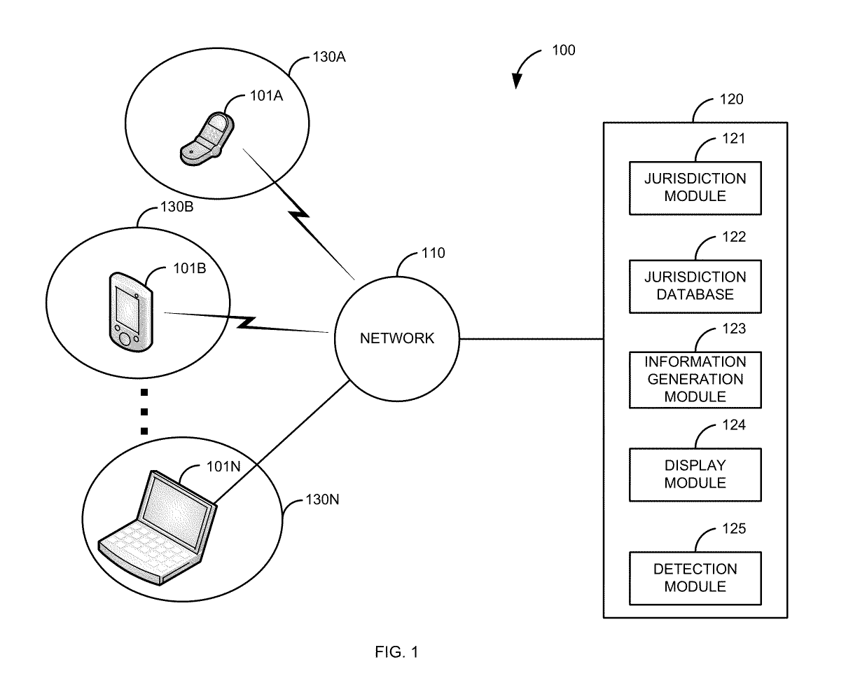

FIG. 1 is a block diagram of a first illustrative system 100 for identification of laws between jurisdictions. The first illustrative system 100 comprises communication devices 101A-101N, a network 110, a communication system 120, and jurisdictions 130A-130N.

The communication devices 101A-101N may be any device that can communicate on the network 110, such as a Personal Computer (PC), a telephone, a video system, a cellular telephone, a Personal Digital Assistant (PDA), a tablet device, a notebook device, and the like. As shown in FIG. 1, any number of communication devices 101A-101N may be connected to the network 110, including only a single communication device 101. In addition, the communication device 101 may be directly connected to the communication system 120.

The network 110 can be any network that can send and receive information, such as the Internet, a Wide Area Network (WAN), a Local Area Network (LAN), the Public Switched Telephone Network (PSTN), a packet switched network, a circuit switched network, a cellular network, a combination of these, and the like. The network 110 can use a variety of protocols, such as Ethernet, Internet Protocol (IP), Session Initiation Protocol (SIP), Integrated Services Digital Network (ISDN), and the like.

The communication system 120 can be any hardware/software that can communicate with the communication devices 101A-101N, such as a Private Branch Exchange (PBX), a server, a central office switch, a web server, a file server, a personal computer, a combination of these, and the like. The communication system 120 comprises a jurisdiction module 121, a jurisdiction database 122, an information generation module 123, a display module 124, and a detection module 125.

The jurisdiction module 121 can be any hardware/software that can manage information associated with different jurisdictions. The jurisdiction database 122 can be any type of database that can store information, such as a relational database, a directory service, a flat file database, an operating system, a file, a hierarchical database, an objected oriented database, a combination of these, and the like. The jurisdiction database 122 contains information related to different jurisdictions 130.

The information generation module 123 can be any hardware/software that can generate information associated with different laws in different jurisdictions. The display module 124 can be any hardware/software that can be used to generate and/or display information. For example, the display module 124 can be a web server, a video card, a Liquid Crystal Display (LCD), a plasma display, a Cathode Ray Tube (CRT), and/or the like. The display module 123 can be distributed. For instance, the display module 123 can be in the communication devices 101A-101N and/or in the communication system 120.

The detection module 125 can be any hardware/software that can detect a behavior, a substance, an item, and/or a device. For example, the detection module 125 can be a Radio Frequency Identification (RFID) system, a substance detector, a camera, an audio detection system, a video camera, a signal detector, and/or the like. The detection module 125 can be distributed between the communication device 101 and the communication system 120 or the detection module 125 can be completely in the communication device 101.

The various elements 121-125 are all shown as part of communication system 120. However, in alternative embodiments, the elements 121-125 may be distributed between the communication system 120, the network 110, and the communication device 101. For example, the jurisdiction database 122 may be in a separate file server. In one embodiment, the jurisdiction module 121, the information generation module 123, the display module 124, and the detection module are all implemented in the communication device 101 and the jurisdiction database 122 is implemented in the communication system 120. One of ordinary skill in the art would recognize that various other combinations are also possible.

The jurisdictions 130A-130N can be any type of jurisdiction where laws are implemented. For instance, a jurisdiction 130 can be a country, a state, a city, a town, a locality, a providence, a county, a territory, an ocean, a lake, a river, a space, and/or the like. A jurisdiction 130 typically has an area associated with the jurisdiction 130. For example, each of the states of the United States has a defined area where the state's laws are applicable. A jurisdiction 130 may comprise multiple jurisdictions 130. For instance the United States comprises 50 different state jurisdictions 130 and each state comprises multiple city jurisdictions 130 (i.e., federal versus state law). A jurisdiction 130 may have laws from other jurisdictions 130. For example, the United States may be subject to some forms of international law based on one or more treaties.

A jurisdiction 130 may comprise an entity, such as a corporation that may have different rules based on a location or subsidiaries of the corporation. A jurisdiction 130 may be an entity (e.g., an organization), such as charity, a religious organization, a partnership, and/or the like.

In FIG. 1, the communication devices 101A-101N are shown in the jurisdictions 130A-130N. Jurisdictions 130A-130N may be the same or different jurisdictions.

The jurisdiction module 121 is configured to receive a request to identify law(s) in a first jurisdiction 130A and law(s) in a second jurisdiction 130B. The law(s) in the first jurisdiction 130A and the second jurisdiction 130B are associated with at least one of a behavior, a substance, an item, and/or a device. The request to identify law(s) in the first jurisdiction 130A and the second jurisdiction 130B can be for a specific type of law. For example, the request may be in regard to a specific type of gun or weapon law, a type of substance or drug law, a law for a type of fruit or animal, a law for a type of cargo being carried, a law for a specific type of device, a law for a specific type of printed material, a combination of these, and the like. The request may be in regard to multiple different types of laws. For instance, the request may include a request for a law associated with an item and a substance. The request may be based on any combination of a behavior, a substance, an item, and/or a device.

The behavior can be any behavior of a user, an animal, an object, a thing, and/or the like. For example, a behavior can be an action by a user of the communication device 101, a gesture made by a user of the communication device 101, whether the user is using or not using a helmet, an action of a dog or other animal, an action of the user with an object or thing, and/or the like. A substance can be any substance, such as a drug, a mineral, a chemical compound, an element, and/or the like. An item can be any item, such as a firearm, a weapon, a firework, a vehicle, an animal, an animal part, a plant, a printed material, an object, a type of clothing or material, an item of furniture, a software application loaded onto or running on a device, and/or the like. A device can be any type of device, such as the communication device 101, a radar detector, a mechanical device, an electronic device, and/or the like.

The jurisdiction module 121 identifies a first law in the first jurisdiction 130A that is associated with the behavior, the substance, the item, or the device. The jurisdiction module 121 identifies a second law in the second jurisdiction 130B that is associated with the behavior, the substance, the item, or the device. In this example, laws are identified in only two jurisdictions 130A and 130B. However, in other embodiments, laws from additional jurisdictions may be identified by the jurisdiction module 121 based on a request to identify laws in more than two jurisdictions 130.

The jurisdiction module 121 identifies the first law in the first jurisdiction 130A and the second law in the second jurisdiction 130B by making a query to the jurisdiction database 122. The jurisdiction database 122 contains information of laws in different jurisdictions 130. The jurisdiction database 122 may contain information on laws only for a specific type of law. For example, the jurisdiction database 122 may contain laws specific to any restricted types of software or devices.

The information generation module 123 generates information associated with the first or second law based on the respective jurisdiction 130. The generated information can be what the law is in the first jurisdiction 130A and what the law is in the second jurisdiction 130B. The generated information is then displayed by display module 124 to a user.

To illustrate, consider the following example, a user is at home on his laptop communication device 101N. The laptop communication device 101N is in the state of Idaho (jurisdiction 130N). The user is planning on taking a trip from Idaho to Nevada (jurisdiction 130A) via California (jurisdiction 130B) (e.g., based on an itinerary). The user is planning on taking his rifle that has a 15 round clip on this trip to do some target shooting in Nevada. The user wants to know what the laws are in the states of Idaho, California, and Nevada to make sure that he/she does not violate any laws on his/her trip.

The user queries the jurisdiction module 121 by sending, from communication device 101N, a request to identify laws for limits on clip sizes in Idaho, California, and Nevada. The jurisdiction module 121 receives the request to identify law(s) for gun clip sizes in the three jurisdictions 101A (Nevada), 101B (California), and 101N (Idaho). The jurisdiction database 122 is queried for this information. The jurisdiction module 121 identifies the applicable laws in the three jurisdictions 101A (Nevada), 101B (California), and 101N (Idaho). The information generation module 123 generates information associated with the three jurisdictions 130A, 130B, and 130N based on the gun clip size laws in Idaho, Nevada, and California. The generated information is then displayed to the user via a web site on the communication device 101N (display module 124).

The user learns that the gun clip limitation in Nevada and Idaho allow for 15 rounds. However, California limits the gun clip size to 7 rounds. Based on this information, the user can alter his/her trip to not go into California, or alternatively, elect to take a 7 round clip so that he/she does not violate any laws on the trip.

Alternatively, if the user changes their itinerary so that he/she will now go through Utah, an additional request to identify laws in Utah can be made based on the user changing his/her itinerary. In addition, the above could be used for planning a future trip to a set of jurisdictions that are different from the user's current jurisdiction.

In another embodiment, the user can enter, via the communication device, a group of jurisdictions (e.g. the United States). A map is displayed that shows all jurisdictions where a particular behavior, a substance, an item, or a device is illegal and/or restricted. For example, states where the behavior, the substance, the item, or the device is legal can be shown in green. Where the behavior, the substance, the item, or the device is illegal can be shown in red.

In another embodiment, laws of overlapping jurisdictions can be checked. For example, if the user is in Denver Colo., the laws of the United States, Colorado, Denver County, and Denver City can be checked. This process can be used for any of the systems and methods described herein.

In another embodiment, the information for jurisdictions can be provided as a service. For example, the information can be provided via a database to various legal services that does not necessarily have to be displayed to a user. The information can be provided in various ways, such as, XML metadata, HTML, voice files, video data, and/or the like.

In one embodiment, the system may comprise a frequent destination cache. The frequent destination cache can be tied to a calendaring system (e.g. Microsoft Outlook™). Based on the search, the user/system could add notes to the calendar event to make sure that the user is compliant with specific laws. The user could define a user profile that contains specific types of areas of interest (i.e., specific types of laws the user is concerned with).

In one embodiment, the system can identify potential WiFi/cellular outages (e.g., non-coverage zones). Based on this information, the user can be alerted prior to entering a non-coverage area.

In another embodiment, the system can be used to determine sales tax (or any kind of tax) between jurisdictions. As the user approaches a jurisdiction, the system can alert the user to a change in the sales tax for the upcoming jurisdiction.

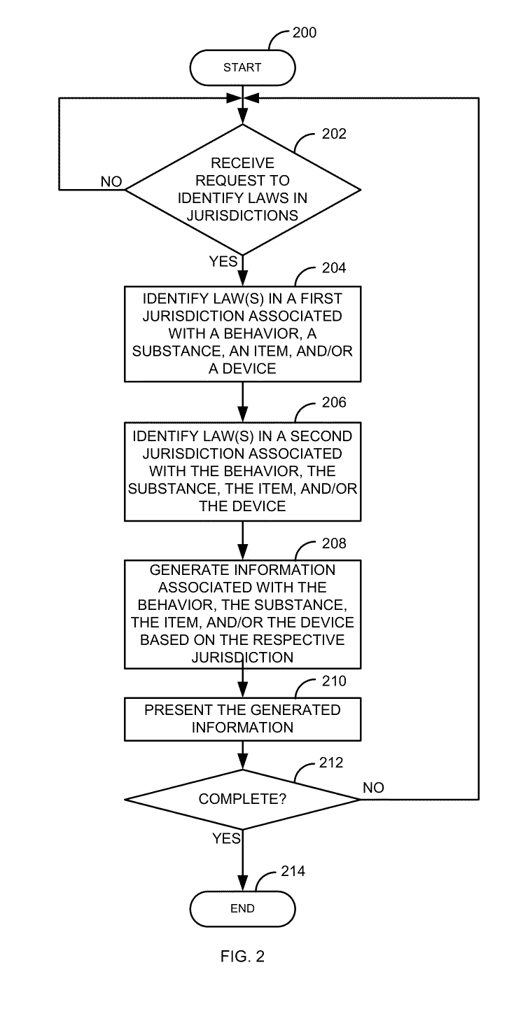

FIG. 2 is a flow diagram of a method for identifying laws between jurisdictions. Illustratively, the communication devices 101A-101N, the communication system 120, the jurisdiction module 121, the jurisdiction database 122, the information generation module 123, the display module 124, and the detection module 125 are stored-program-controlled entities, such as a computer or processor, which performs the method of FIGS. 2-6 and the processes described herein by executing program instructions stored in a tangible computer readable storage medium, such as a memory or disk. Although the methods described in FIGS. 2-6 are shown in a specific order, one of skill in the art would recognize that the steps in FIGS. 2-6 may be implemented in different orders and/or be implemented in a multi-threaded environment. Moreover, various steps may be omitted or added based on implementation.

The process starts in step 200. The process determines if a request is received to identify laws in a first and second jurisdiction that are associated with a behavior, a substance, an item, and/or a device in step 202. If a request is not received in step 202, the process repeats step 202. Otherwise, if request is received in step 202, the process identifies 204 law(s) in a first jurisdiction associated with the behavior, the substance, the item, and/or the device. The process identifies 206 law(s) in a second jurisdiction associated with the behavior, the substance, the item, and/or the device. The process can also identify laws in additional jurisdictions if requested.

The process generates 208 the information associated with the behavior, the substance, the item, and/or the device based on the respective jurisdiction. The generated information is presented 210 to the user. The process determines in step 212 if the process is complete. If the process is not complete in step 212, the process goes to step 202 to wait for a request to identify laws. Otherwise, if the process is complete in step 212, the process ends 214.

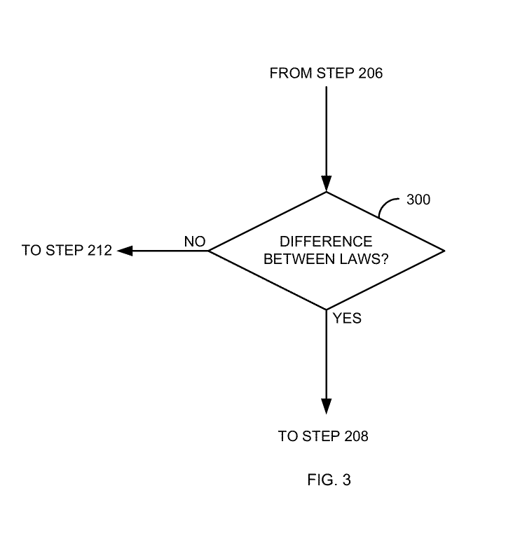

FIG. 3 is a flow diagram of a method for identifying differences in laws between jurisdictions. The process in FIG. 3, in this exemplary embodiment, that may go between steps 206 and 208 of FIG. 2. After the process has identified laws in a second jurisdiction associated with the behavior, the substance, the item, and/or the device in step 206, the process determines in step 300 if there is a difference between the first law in the first jurisdiction and the second law in the second jurisdiction. If there is no difference between the first law in the first jurisdiction and the second law in the second jurisdiction in step 300, the process goes to step 212 (bypassing steps 208 and 210).

Otherwise, if there is a difference between the first law in the first jurisdiction and the second law in the second jurisdiction in step 300, the process goes to step 208 and generates the information associated with the behavior, the substance, the item, and/or the device based on the difference between the first law in the first jurisdiction and the second law in the second jurisdiction.

To illustrate, consider the following example. The user is planning a trip from New York, to Maine, and then to Canada. The user is planning on using a car that auto-navigates (where a computer drives the car instead of a user). Upon making the request to identify laws associated with auto-navigated cars, the process identifies that the laws in New York and Maine allow for a car to be auto-navigated in New York and Maine. However, Canadian law does not allow the use of auto-navigated cars.

In this example, the generated information would only indicate the difference between Maine and Canada (in Maine, the auto-drive can be enabled and in Canada, the auto-drive cannot be used). The process would not identify a difference between New York and Maine law because the laws are the same. This way the user would be aware that when he/she reaches Canada, that he/she will need to drive the car instead of using the auto-navigation.

In another embodiment, the process can determine a difference between laws by determining a lowest common law. For example, consider the previous example of using gun clip sizes. In this example, the process would generate information that indicates that lowest common gun clip size (15 in Idaho, 7 in California, and 15 in Nevada) in each of the jurisdictions would be 7 rounds.

In another embodiment, the process can determine differences in laws at any given point in time. For example, the user may want to display the differences in laws that were in place three years earlier, display laws that will be in place in two months (i.e. when the user is going to take a trip), or display laws at the current point in time.

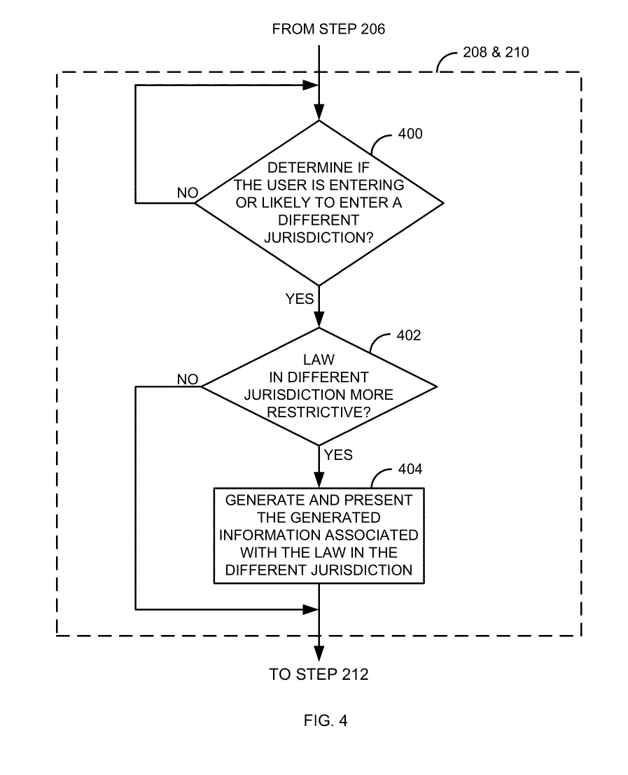

FIG. 4 is a flow diagram of a method for determining if a law is more restrictive in a different jurisdiction. The process in FIG. 4 is an embodiment of steps 208 and 210 in FIG. 2. After identifying the laws associated with the jurisdictions in step 204 and 206, the process determines in step 400 if the user is entering or likely to enter a different jurisdiction. For example, if the user is going from the first jurisdiction to the second jurisdiction (or a new jurisdiction). If the user is not entering or likely to enter a different jurisdiction in step 400, the process repeats step 400.

The process can determine that a user is entering a jurisdiction in various ways. For example, based on Global Positioning Satellite (GPS), cellular triangulation, user input (e.g., the user saying entering Los Angles), a connection to a network, and/or the like. The process can determine that a user is likely to enter a jurisdiction in various ways. For instance, based on a projected heading, being within a specific distance of a jurisdiction, based on a heading and a map, based on a heading and itinerary, based on a user defined distance, and/or the like.

If the process determines in step 400 that the user is entering or likely entering a different jurisdiction, the process determines in step 402 if the law in the different jurisdiction is more restrictive. If the law is not more restrictive in step 402, the process goes to step 212. Otherwise, if the process determines in step 402 that the law in the different jurisdiction is more restrictive, the process generates and presents 404 the generated information associated with the law in the different jurisdiction. The process then goes to step 212.

To illustrate, consider the following example. Assume that the user is about to cross the border between California and Oregon. Oregon has no restrictions on carrying fruit in or out the state. However, California only allows fruit to be carried into California if the user has a permit. The user has indicted that he wants to be warned regarding any changes in any jurisdiction of laws regarding carrying of fruit across a border. Based on GPS information, as the user approaches the border, the process determines that the user is likely to enter California from Oregon. The process generates and presents information that indicates that the user can only bring fruit into California based on the user having a specific permit. In this example, because the user is carrying a couple of items of fruit that he purchased in Oregon, the user now knows that he cannot not carry the purchased fruit into California because he does not have a permit.

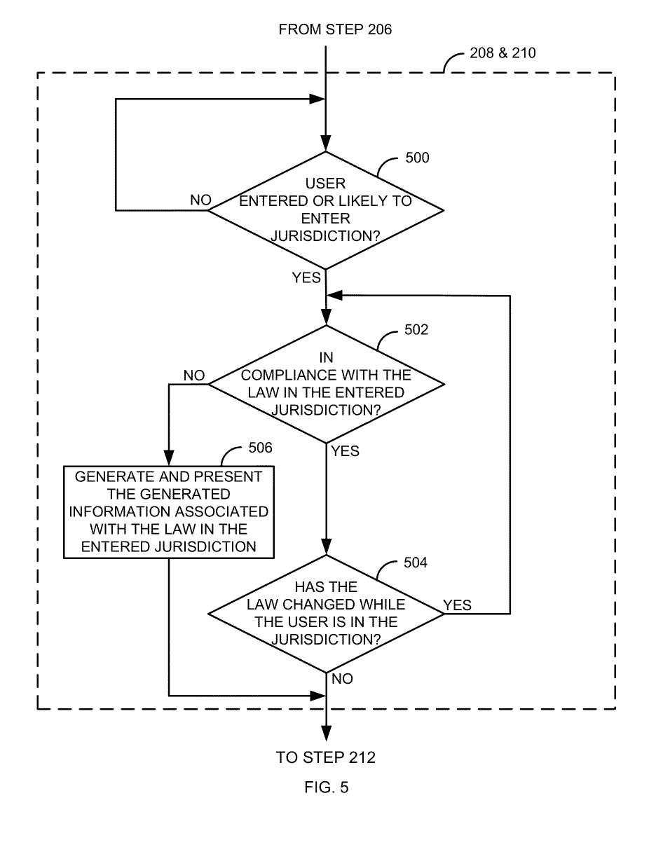

FIG. 5 is a flow diagram of a method for determining if a user is in compliance with the laws in an entered jurisdiction. The process in FIG. 5 is another embodiment of steps 208 and 210 in FIG. 2. After identifying the laws associated with the jurisdictions in step 204 and 206, the process determines in step 500 if the user is entering or likely to enter a different jurisdiction. If the user is not entering or likely to enter a different jurisdiction in step 500, the process repeats step 500.

If the user is entering or likely to enter the jurisdiction (e.g., based on proximity, direction, velocity of movement, or itinerary planning (even if the itinerary states differently)) in step 500, the process determines in step 502 that the user is in compliance with the law in the entered jurisdiction. The process can determine if a user is in compliance with the law in the entered jurisdiction in various ways. For example, the process can determine that the user is in compliance with the law based on the user indicating that the user is in compliance, based on detecting that the user is carrying/using or not carrying/not using an item or device (e.g., based on detecting that the user does not have his helmet on), by detecting an item based with an RFID tag, based on a gesture from the user, based on sensor (e.g. a substance detector), and/or the like. The detected information is compared to the law in the entered jurisdiction.

If the user is not in compliance with the law in the entered jurisdiction in step 502, the process generates and presents 506 the information associated with the law in the entered jurisdiction. The process then goes to step 212. Otherwise, if the user is in compliance with the law in the entered jurisdiction in step 502, the process detects if the law has changed while the user is in the jurisdiction. If the law has changed while the user is in the jurisdiction the process goes to step 502 to determine if the user is incompliance with the changed law. Otherwise, if the law has not changed while the user is in the jurisdiction in step 504, the process goes to step 212 (e.g., when the user leaves the jurisdiction).

To illustrate, consider the following examples. The user enters Canada on December 31th. The user is carrying a multi-vitamin supplement that includes vitamin K. When the user entered Canada on December 31, the law in Canada is that vitamin K is legal. However, Canada has passed a new law that makes carrying any multi-vitamins that contain vitamin K illegal beginning on January 1. The user is still in Canada on January 1. The process determines that the user is no longer in compliance with the law in Canada. The process generates and presents information associated with the new law that vitamin K is now illegal in Canada. The user can then take the appropriate action.

In another example, in India, it is illegal to make telephone calls that bypass the Indian telecommunication system. The user is traveling to India and has a software application that allows the user to make direct telephone calls that bypass the telecommunication system in India. When the user enters India, he is in compliance because he is not using the software application. At a later point in time, when the user attempts to bring up the software application, the process determines (e.g., based on detection of a Session Initiation Protocol (SIP) message that bypasses the Indian telecommunication system) that the user is attempting to bypass the Indian telecommunication system. In one embodiment, the user is warned of the illegal behavior. Alternatively, the software application could automatically be directed to the Indian telecommunication system to ensure compliance with Indian law.

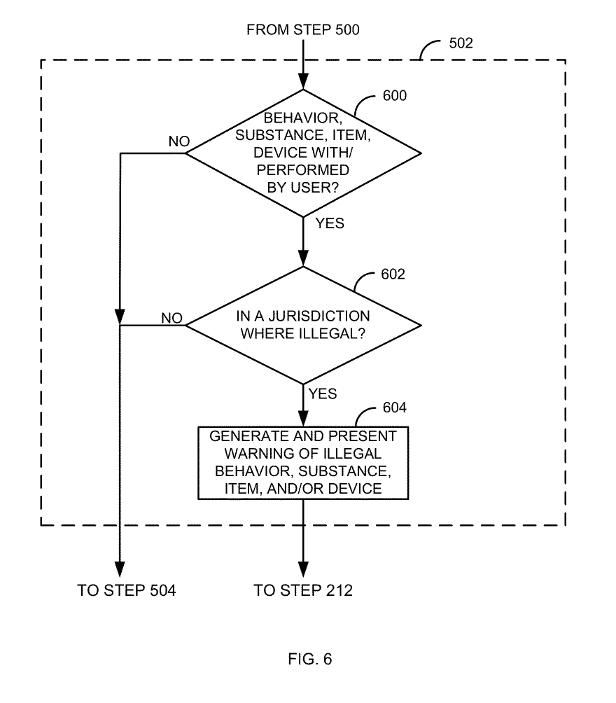

FIG. 6 is a flow diagram of a method for detecting if a behavior, a substance, an item, and/or a device is with a user or being performed by the user in a jurisdiction where the behavior, the substance, the item, and/or the device is illegal. The process in FIG. 6 is an exemplary embodiment of step 502 in FIG. 5. Once the user has entered the jurisdiction in step 500 the process determines in step 600 if a behavior is being performed by a user or if a substance, an item, or a device is with the user. If the behavior is not being performed and the substance, the item, or the device is not with the user in step 600, the process goes to step 504.

Otherwise, if the behavior is being performed and/or if the substance, the item, or the device is with the user in step 600, the process determines if the behavior, the substance, the item, or the device is illegal in the jurisdiction. If the behavior, the substance, the item, or the device is not illegal in step 602, the process goes to step 504. Otherwise, if the behavior, the substance, the item, or the device is illegal in step 602, the process generates and presents 604 a warning of the illegal behavior, substance, item and/or device. The process goes to step 212.

To illustrate, consider the following examples. In Russia, it is illegal to take pictures by a foreigner of certain types of things, such as bridges, and other types of infrastructure. As the user enters Russia, the user takes a picture of a friend in her apartment. In this example, the process would determine that the behavior (taking a picture of a restricted item) was not being performed. Later on, the user takes a picture of a bridge. The process determines that the behavior is being performed. The process determines that the user is still in Russia (for example, based on GPS) where the behavior is being performed. The process determines in step 620 that the behavior (taking a picture of a bridge) is illegal in the jurisdiction (Russia). The process generates and presents a warning of the illegal activity. In one embodiment, the user may be prevented from taking the picture.

In a second example, the action is firing of missiles from an airplane or drone. According to international law, a missile can only be fired and exploded in a country approved by the United Nations. In Afghanistan, firing and exploding missiles is allowed. However, this is not legal in Pakistan. If a pilot flying in Afghanistan along the Pakistani border is going to fire a missile that will explode in Pakistan, the pilot will be warned of the illegal behavior of firing the missile into Pakistan. In this example, there are two different behaviors that are tracked: 1) where the missile is fired from, and 2) where the missile will explode.

In a third example, as the user is about to enter a jurisdiction, the process detects if the user is carrying a particular substance (e.g., via a substance detector) or item (e.g., based on an RFID tag attached to the item that is detected by the user's communication device). If the process determines that the substance or the item is illegal in the jurisdiction, the user is warned of the illegal substance or item. For example, the user's passport may have an RFID tag that the user's communication device identifies to alert the user to get his passport ready (or alert the user if the passport is not detected). Alternatively, an RFID tagged/GPS tracked item such as a shipping pallet or shipping container can be monitored as the item approaches a new jurisdiction to notify a company of a possible violation of laws in the new jurisdiction.

In a fourth example, the process can be used by law enforcement personnel that support multiple jurisdictions that have different laws. A police officer could use the system to be warned if he is in an area where he can issue a ticket based on the police officer's location. If the police officer is outside the jurisdiction, the system can warn the police officer that he cannot issue a ticket.

All the above examples are some of many examples that can be used in conjunction with the above systems and methods. In addition, the above systems and methods can be used to alert travelers of passport issues, registrations, required shots for entry to a country, necessary documents, proper use of items, proper storage of items, city ordinances, and/or the like.

Of course, various changes and modifications to the illustrative embodiment described above will be apparent to those skilled in the art. These changes and modifications can be made without departing from the spirit and the scope of the system and method and without diminishing its attendant advantages. The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
receiving a request to identify laws in a first and second jurisdiction that are associated with at least one of a behavior, a substance, an item, and a device;
identifying a first law in the first jurisdiction associated with the at least one of the behavior, the substance, the item, and the device;
identifying a second law in the second jurisdiction associated with the at least one behavior, the substance, the item, and the device; and
generating information associated with at least one of the first law or the second law based on the respective jurisdiction of the first or second law.

2. The method of claim 1, further comprising:
determining if there is a difference between the first law and the second law; and
in response to determining that there is a difference between the first law and the second law, presenting the generated information associated with the at least one of the first law or the second law as the difference between the first law and the second law.

3. The method of claim 1, further comprising:
determining that the user will enter or likely enter the second jurisdiction from the first jurisdiction;
in response to determining that the user will enter or likely enter the second jurisdiction from the first jurisdiction, determining if the second law is more restrictive than the first law;
in response to determining that the second law is more restrictive than the first law, presenting the generated information associated with the second law; and
in response to determining that the second law is not more restrictive than the first law, not presenting the generated information associated with the at least one of the first law or the second law.

4. The method of claim 3, wherein the laws in the first and second jurisdiction are associated with the substance or the item and further comprising detecting that a user is carrying the substance or the item.

5. The method of claim 1, wherein the laws in the first and second jurisdiction are associated with the behavior and further comprising:
detecting that the behavior is being performed by a user;
in response to detecting that the behavior is being performed by the user, determining what jurisdiction the behavior is occurring;
in response to determining what jurisdiction the behavior is occurring, determining if the behavior is illegal in the jurisdiction that the behavior is occurring; and
in response to determining that the behavior is illegal in the jurisdiction that the behavior is occurring, warning the user of the illegal behavior.

6. The method of claim 1, wherein the laws in the first and second jurisdiction are associated with the device.

7. The method of claim 1, wherein a user is in the first jurisdiction, wherein when the user entered the first jurisdiction the user was in compliance with the first law and further comprising:
detecting that the first law has changed while the user is still in the first jurisdiction; and
in response to detecting that that the first law has changed while the user is still in the first jurisdiction, warning the user of the changed first law.

8. The method of claim 7, wherein the user is warned of the changed first law if user is no longer in compliance with the changed first law.

9. The method of claim 1, wherein the request to identify the laws in the first and second jurisdiction is based on a projected itinerary.

10. The method of claim 1, wherein an additional request to identify laws in a third jurisdiction is generated based on a change to a projected itinerary or based on a user entering or likely entering the third jurisdiction.

11. The method of claim 1, wherein the request comprises a request for laws associated at least two of the behavior, the substance, the item, or the device.

12. A system comprising:
a jurisdiction module configured to receive a request to identify laws in a first and second jurisdiction that are associated with at least one of a behavior, a substance, an item, and a device, identify a first law in the first jurisdiction associated with the at least one of the behavior, the substance, the item, and the device, and identify a second law in the second jurisdiction associated with the at least one behavior, the substance the item, and the device; and
an information generation module configured to generate information associated with at least one of the first law or the second law based on the respective jurisdiction of the first law or the second law.

13. The system of claim 12, wherein:
the jurisdiction module is further configured to determine if there is a difference between the first law and the second law; and
a display module configured to present the generated information associated with the at least one of the first law or the second law as the difference between the first law and the second law in response to determining that there is a difference between the first law and the second law.

14. The system of claim 12, wherein:
the jurisdiction module is further configured to determine that the user will enter or likely enter the second jurisdiction from the first jurisdiction, determine if the second law is more restrictive than the first law in response to determining that the user will enter or likely enter the second jurisdiction from the first jurisdiction; and
a display module is configured to present the generated information associated with the second law in response to determining that the second law is more restrictive than the first law and not present the generated information associated with the at least one of the first law or the second law in response to determining that the second law is not more restrictive than the first law.

15. The system of claim 14, wherein the laws in the first and second jurisdiction are associated with the substance or the item and a detection module is configured to detect that a user is carrying the substance or the item.

16. The system of claim 12, wherein the laws in the first and second jurisdiction that are associated with the behavior and wherein:
a detection module is configured to detect that the behavior is being performed by a user; and
the jurisdiction module is further configured to determine what jurisdiction the behavior is occurring in response to detecting that the behavior is being performed by the user, determine if the behavior is illegal in the jurisdiction that the behavior is occurring in response to determining what jurisdiction the behavior is occurring, and warn the user of the illegal behavior in response to determining that the behavior is illegal in the jurisdiction that the behavior is occurring.

17. The system of claim 12, wherein the laws in the first and second jurisdiction are associated with the device.

18. The system of claim 12, wherein a user is in the first jurisdiction wherein when the user entered the first jurisdiction, the user was in compliance with the first law and wherein:
a detection module is configured to detect that the first law has changed while the user is still in the first jurisdiction; and
the information generation module is configured to warn the user of the changed first law in response to detecting that that the first law has changed while the user is still in the first jurisdiction, wherein the user is warned of the changed first law if user is no longer in compliance with the changed first law.

19. The system of claim 12, wherein an additional request to identify laws in a third jurisdiction is generated based on a change to a projected itinerary or based on a user entering or likely entering the third jurisdiction.

20. A non-transient computer readable medium having stored thereon instructions that cause a processor to execute a method, the method comprising:
instructions to receive a request to identify laws in a first and second jurisdiction that are associated with at least one of a behavior, a substance, an item, and a device;
instructions to identify a first law in the first jurisdiction associated with the at least one of the behavior, the substance, the item, and the device;
instructions to identify a second law in the second jurisdiction associated with the at least one behavior, the substance, the item, and the device; and
instructions to generate information associated with at least one of the first law or the second law based on the respective jurisdiction of the first or second law.
